(19) United States
(12) Patent Application Publication
(10) Pub. No.: US 2001/0020297 A1
(43) Pub. Date: Sep. 6, 2001

(54) Apparatus for and method of displaying program guide

(76) Inventor: Tatsu Inoue, Tokyo-to (JP)

Correspondence Address: SUGHRUE, MION, ZINN, MACPEAK & SEAS, 2100 Pennsylvania Avenue, N.W., Washington, DC, 20037, US

(21) Appl. No.: 09/750,689

(22) Filed: Jan. 2, 2001

(30) Foreign Application Priority Data
Mar. 2, 2000 (JP) P2000-61850

(51) Int. Cl. G06F 3/00; H04N 5/445

(52) U.S. Cl. 725/39

(57) ABSTRACT

An apparatus for displaying a program guide is provided with: a storing device for storing contract conditions of a plurality of programs; a program information receiving device for receiving information about programs; a program selection accepting device for accepting a selection of a desirable program from a plurality of the programs; a contract conditions reading device for reading the contract conditions corresponding to a selected program whose selection is accepted; a program information reading device for reading the information about the selected program; a determining device for determining whether the selected program is allowed to be viewed by comparison between the read information and the read contract conditions; and a displaying device for displaying information to specify the selected program, and information on the basis of the result of determining by the determining device on an identical screen, at least if the result of determining is that the selected program is not allowed to be viewed.

### BACKGROUND OF THE INVENTION

1. Field of the Invention

The present invention relates to the field of an apparatus for and a method of displaying program guide, and more particularly relates to an apparatus for and a method of displaying an Electronic Program Guide (hereinafter referred to EPG).

2. Description of the Related Art

In recent years, a digital broadcasting system, in which a digitized television signal is transmitted through a artificial satellite like a communications satellite, etc. and received at each house of viewers to view television programs, is brought into service. In this kind of system, it is possible to allocate a lot of channels, so that a large number of programs can be broadcast.

Accordingly, in such a system, information about an EPG indicating the contents of the large number of programs is transmitted with image and audio information of the programs through the satellite to a receiver installed in each house of the viewers. In each house, a user operates the receiver so that the EPG is displayed on a TV display, and finds a desired program. Generally, the user can find the desired program in the displayed EPG by using a remote controller, etc. attached to the receiver. However, in the programs on the displayed EPG, the program of conditional access type, which can be watched only after the user signs up with a broadcasting company. Therefore, if the program is received before the user signs up, screen image of the program is disturbed and the reason of the disturbance is displayed on the screen.

In this manner, when the user selects a program from programs on the displayed EPG, namely, before the program is received, the user can not know whether a program is allowed to be viewed or not in the conventional system.

Further, in the conventional system, if the program is received before the user signs up, screen image of the program is disturbed. Therefore, the user can not recognize the contents of the program.

### SUMMARY OF THE INVENTION

It is therefore an object of the present invention to provide an apparatus for and a method of displaying program guide, which enables the user to promptly know whether a program can be watched or not, and to easily recognize the contents of the program.

The above object of the present invention can be achieved by an apparatus for displaying a program guide. The apparatus has a storing device, a program information receiving device, a program selection accepting device, a contract conditions reading device, a program information reading device, a determining device, and a displaying device. The storing device stores contract conditions of a plurality of programs. The program information receiving device receives information about programs. The program selection accepting device accepts a selection of a desirable program from a plurality of the programs. The contract conditions reading device reads the contract conditions corresponding to a selected program whose selection is accepted. The program information reading device reads the information about the selected program. The determining device determines whether the selected program is allowed to be viewed by comparison between the read information and the read contract conditions. The displaying device displays information to specify the selected program, and information on the basis of the result of determining by the determining device on an identical screen, at least if the result of determining is that the selected program is not allowed to be viewed.

According to the apparatus of the present invention, the information about the programs is received by the program information receiving device. Then a desirable program is selected by a user on the basis of the information and the program selection accepting device accepts the selection of the desirable program. Then the contract conditions reading device reads the contract conditions corresponding to the selected program, for example, the contract conditions indicating whether the selected program is allowed to be viewed or not. Then the program information reading device reads the information about the selected program, for example, information indicating whether the selected program is a free-of-charge program or a pay-per-view program. Then the determining device determines whether the selected program is allowed to be viewed by comparison between the read information and the read contract conditions. Then the displaying device displays information to specify the selected program, and information on the basis of the result of determining by the determining device on an identical screen, at least if the result of determining is that the selected program is not allowed to be viewed.

Therefore, the information to specify the selected program and the information on the basis of the result of determining by the determining device is displayed on the identical screen while the user selects the program, at least if the result of determining is that the selected program is not allowed to be viewed, so that he can promptly and easily realize whether the selected program is allowed to be viewed or not.

In one aspect of the apparatus of the present invention, the displaying device also displays information on the basis of the result of determining by the determining device on the identical screen, if the result of determining is that the selected program is allowed to be viewed.

Therefore, the user can promptly and easily realize whether the selected program is allowed to be viewed or not, in another aspect of the apparatus of the present invention, the information about programs read by the program information receiving device is provided by EPG data.

Therefore not only the user can realize the information to specify the program on the basis of EPG screen, but also the processing by the devices of the present invention is easily performed on the basis of the EPG data.

In another aspect of the apparatus of the present invention, the information about programs read by the program information reading device includes at least a name of the programs, information about the contents of the programs, start time of the programs, length of the programs or finish time of the programs, broadcasting channels of the programs, broadcasting dates of the programs, and viewing conditions of the programs. Further, the determining device determines whether the selected program is allowed to be viewed by comparison between the read viewing conditions and the read contract conditions. Moreover, the displaying device displays at least the name of the selected program, the contents of the selected program, and information on the basis of the result of determining by the determining device on the identical screen, at least if the result of determining is that the selected program is not allowed to be viewed.

Therefore, appropriate information to specify the selected program and appropriate information on the basis of the result of determining by the determining device is displayed on the identical screen while the user selects the program, at least if the result of determining is that the selected program is not allowed to be viewed, so that he can promptly and easily realize whether the selected program is allowed to be viewed or not.

In another aspect of the apparatus of the present invention, the displaying device also displays information on the basis of the result of determining by the determining device on the identical screen, if the result of determining is that the selected program is allowed to be viewed.

Therefore, the user can promptly and easily realize whether the selected program is allowed to be viewed or not.

In another aspect of the method of the present invention, the information about programs read by the program information receiving process is provided by EPG data.

Therefore not only the user can realize the information to specify the program on the basis of EPG screen, but also the processing by the devices of the present invention is easily performed on the basis of the EPG data.

The above object of the present invention can be achieved- by a method of displaying a program guide. The method has the process of storing contract conditions of a plurality of programs, the process of receiving information about programs, the process of accepting a selection of a desirable program from a plurality of the programs, the process of reading the contract conditions corresponding to a selected program whose selection is accepted, the process of reading the information about the selected program, the process of determining whether the selected program is allowed to be viewed by comparison between the read information and the read contract conditions, and the process of displaying information to specify the selected program, and information on the basis of the result of determining by the determining device on an identical screen, at least if the result of determining is that the selected program is not allowed to be viewed.

According to the method of the present invention, the information about the programs is received. Then a desirable program is selected by a user on the basis of the information and the selection of the desirable program is accepted. Then the contract conditions corresponding to the selected program is read, for example, the contract conditions indicating whether the selected program is allowed to be viewed or not. Then the information about the selected program is read, for example, information indicating whether the selected program is a free-of-charge program or a pay-per-view program. Then it is determined whether the selected program is allowed to be viewed by comparison between the read information and the read contract conditions. Then the information to specify the selected program and information on the basis of the result of determining is displayed on the identical screen, at least if the result of determining is that the selected program is not allowed to be viewed.

Therefore, the information to specify the selected program and the information on the basis of the result of determining is displayed on the identical screen while the user selects the program, at least if the result of determining is that the selected program is not allowed to be viewed, so that he can promptly and easily realize whether the selected program is allowed to be viewed or not.

In one aspect of the method of the present invention, the process of displaying information also displays information on the basis of the result of determining by the determining device on the identical screen, if the result of determining is that the selected program is allowed to be viewed.

Therefore, the user can promptly and easily realize whether the selected program is allowed to be viewed or not.

In another aspect of the method of the present invention, the received information about programs is provided by EPG data.

Therefore not only the user can realize the information to specify the program on the basis of EPG screen, but also the processing by the present invention is easily performed on the basis of the EPG data.

In another aspect of the method of the present invention, the received information about programs includes at least a name of the programs, information about the contents of the programs, start time of the programs, length of the programs or finish time of the programs, broadcasting channels of the programs, broadcasting dates of the programs, and viewing conditions of the programs. Further, the process of determining determines whether the selected program is allowed to be viewed by comparison between the read viewing conditions and the read contract conditions. Moreover, the process of displaying displays at least the name of the selected program, the contents of the selected program, and information on the basis of the result of determining on the identical screen, at least if the result of determining is that the selected program is not allowed to be viewed.

Therefore, appropriate information to specify the selected program and appropriate information on the basis of the result of determining is displayed on the identical screen while the user selects the program, at least if the result of determining is that the selected program is not allowed to be viewed, so that he can promptly and easily realize whether the selected program is allowed to be viewed or not.

In another aspect of the method of the present invention, the process of displaying information also displays information on the basis of the result of determining by the determining device on the identical screen, if the result of determining is that the selected program is allowed to be viewed.

Therefore, the user can promptly and easily realize whether the selected program is allowed to be viewed or not.

In another aspect of the method of the present invention, the received information about programs is provided by EPG data.

Therefore not only the user can realize the information to specify the program on the basis of EPG screen, but also the processing by the present invention is easily performed on the basis of the EPG data.

### BRIEF DESCRIPTION OF THE DRAWINGS

FIG. 1 is a block diagram showing a configuration of a digital satellite broadcasting receiver according to an embodiment of the present invention;

FIG. 2 is a block diagram showing a format of data in digital satellite broadcasting system;

FIG. 3 is a view showing an example of a screen image of a Day-EPG displayed on a display;

FIG. 4 is a view showing an example of a screen image of a Detailed-Program-Information EPG displayed on a display;

FIG. 5 is an outline view showing a remote controller used with the receiver shown in FIG. 1;

FIG. 6 is a flow chart showing processing of displaying the Detailed-Program-Information EPG; and

FIG. 7 is a flow chart showing processing of displaying detailed program information in the processing of FIG. 6.

### DETAILED DESCRIPTION OF THE PREFERRED EMBODIMENT

A preferred embodiment of the present invention will be explained below with reference to the drawings.

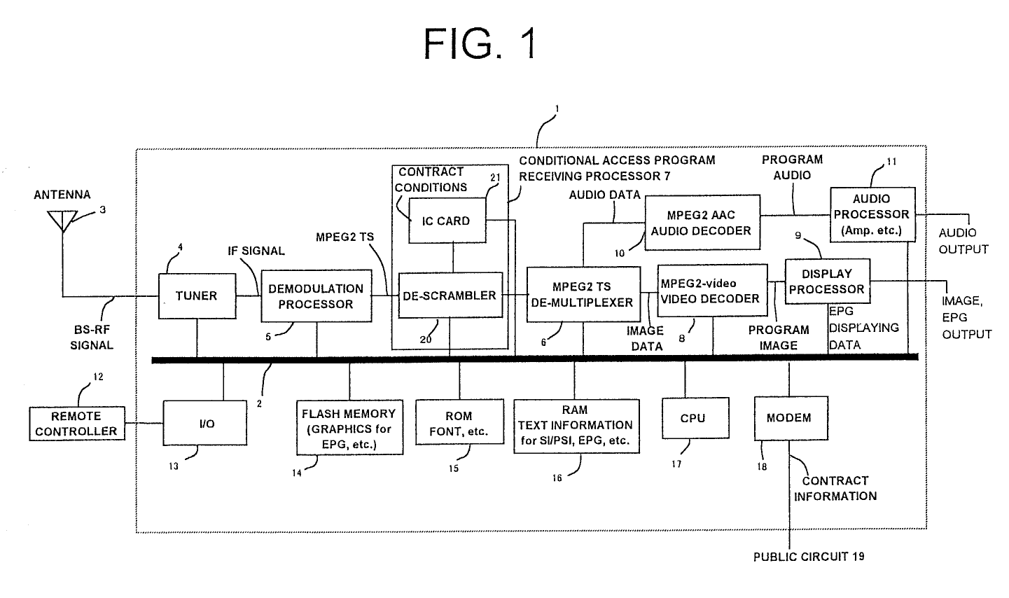

FIG. 1 shows the configuration of a digital satellite receiver according to an embodiment of the present invention. A digital satellite receiver 1 shown in FIG. 1, which is installed at a house of a viewer, receives a digital broadcast signal (a broadcast wave) transmitted from a communications satellite, and displays a television (TV) program on a screen of a television (TV) receiver installed at the house. At the same time, the digital satellite receiver 1 receives information about EPG transmitted from the communications satellite, and displays it on the screen under the control of the viewer.

As shown in FIG. 1, the receiver 1 is configured so that variety of elements are connected to a bus 2. The digital satellite receiver 1 can be operated by an attached remote controller 12.

The broadcast wave (BS-RF signal) transmitted from the communications satellite is received through an antenna 3, and sent to a tuner 4 in the receiver 1. In the broadcast wave, image and audio information of the TV program (hereinafter referred to “TV program information”) is included, and Service Information (hereinafter referred to SI) used for displaying EPG is also included. The tuner 4 converts the received broadcast wave, which is tuned in a receiving frequency band selected by a user, into an IF (intermediate frequency) signal, and then transmits it to a demodulation processor 5. The demodulation processor 5 demodulates the input digital signal, performing necessary processing, such as re-configuration of data frame, error correcting, etc., and providing data in the form of MPEG2-Transport Stream (hereinafter referred to MPEG2-TS) to a de-multiplexer 6 through a de-scrambler 20.

The de-multiplexer 6 extracts audio data and image data of a designated service from input MPEG2-TS, and provides audio data to an audio decoder 10 and image data to a video decoder 8. The audio data is provided in the forms of MPEG2-AAC, and the image data is provided in the forms of MPEG2-Video. The audio decoder 10 decodes input audio data, generating program audio data and providing it to an audio processor 11. The audio processor 11 includes an amplifier and performs predetermined audio signal processing so as to generate audio output.

On the other hand, the video decoder 8 decodes the image data, generating program image data, and providing it to a display processor 9. The display processor 9 performs predetermined processing to the input program image data so as to generates image output. The display processor 9 has the function of superimposing textual information, etc. on screen image of a program displayed on a screen of a TV display. EPG displaying data described below is superimposed on the program image data or replaced with the program image data by the display processor 9, and displayed on the TV display.

The de-multiplexer 6 extracts data including SI, which is one other than the TV program information, from the input MPEG2-TS. SI is a source of the EPG displaying data. EPG display processing is performed by using SI. The data, such as SI, etc., which is extracted by the de-multiplexer 6, is stored in a RAM 16 under the control of a CPU 17. EPG text data for displaying EPG is also stored the RAM 16. The RAM 16 is provided as a nonvolatile RAM. A flash memory 14 stores variety of graphic data, such as a frame of program table, a logo of a broadcasting channel, etc. A ROM 15 stores font data used for the EPG text data.

A conditional access program receiving processor 7 performs the following processing. A conditional access for which the user has to sign up in advance is broadcast by a service or a program an object MPEG2-TS is transmitted as encrypted data. The conditional access program receiving processor 7 includes the de-scrambler 20 decoding the encrypted data and an IC card 21 in which information about contract between the user and the broadcasting company is written. The IC card 21 is provided to a user of each receiver from a service center jointly run with the broadcasting companies. The information about the contract written in the IC card 21 includes contract conditions indicating whether a program is allowed to be viewed or not. Generally, the contents of the contract conditions vary between users. According to the contract conditions, for example, a channel on which the user can view a program by a month or a year, and a program which the user can view by a month or a year are determined. The information about the contract written in the IC card 21 is stored in the RAM 16 under the control of the CPU 17. When the user selects a program of the conditional access, the conditional access program receiving processor 7 decodes the encrypted data of MPEG2-TS by using both of the contract conditions and information about decoding encrypted data obtained from the broadcast wave if the user makes the contract with the broadcasting company. Consequently, the user can view the program. On the other hand, if the user does not make the contract with the broadcasting company, the encrypted data of MPEG2-TS is not decoded. Consequently, the user can not view the program. In this case, information indicating that the user can not view the program stored in the ROM 15, etc. is displayed on the EPG displaying screen. Further, the information about the contract can be provided from the broadcasting company to the receiver through a public circuit 19 and a modem 18. The provided information about the contract can be stored in the RAM 16 under the control of the CPU 17.

In the case of a Pay Per View program, a purchasing status is written in the IC card 21 every time the user purchases the program. Then information about purchasing a Pay Per View program is transmitted from the receiver to the broadcasting company through the modem 18 and the public circuit 19 at regular intervals.

If the user inputs the instruction into the receiver 1 by using the remote controller 12, it is sent to the CPU 17 through an interface 13 and recognized by the CPU 17. The CPU 17 controls each element in the receiver 1 in accordance with the instruction. For example, the CPU 17 controls the tuner 4 so that it tunes in a frequency of a channel designated by the user.

At the time of displaying EPG, the CPU 17 generates EPG text data on the basis of SI stored in the RAM 16. Then the CPU 17 generates EPG displaying data by using graphic data like frame data of the program table, etc. stored in the flash memory 14, font data stored in the ROM 15, and the EPG text data, providing it to the display processor 9. The display processor 9 switches between program image data from the video decoder 8 and the EPG displaying data on the basis of the instruction of switching from the CPU 17, or superimposes the EPG displaying data on the program image data, outputting it to the TV display not shown in drawings as a image signal.

The bus 2 is connected to the public circuit 19 through the modem 18, so that necessary communication between a broadcasting station and the viewer's house can be performed.

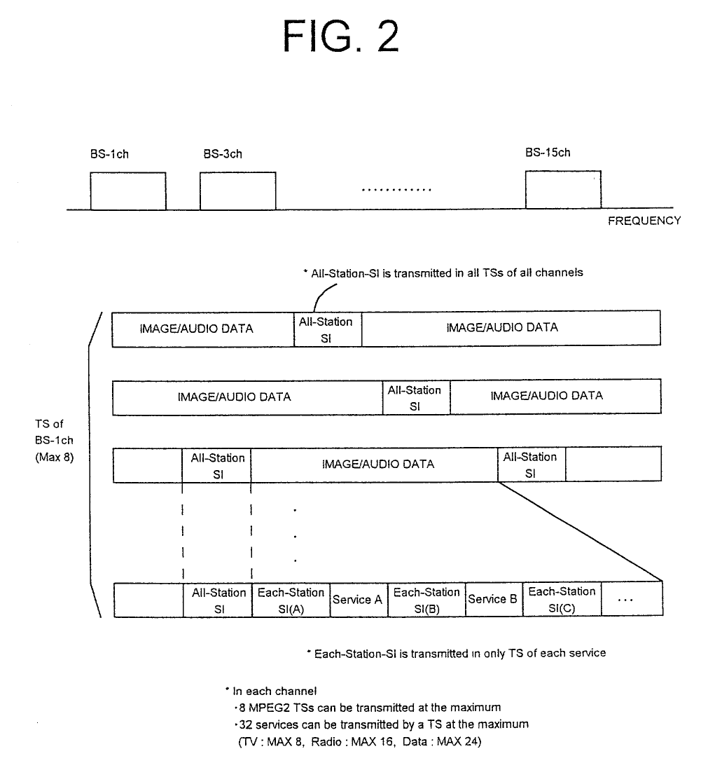

Next, a digital signal transmitted from the communications satellite as a source of the EPG displaying data will be explained. A data format of the digital signal is schematically indicated in FIG. 2. As shown in FIG. 2, in digital satellite broadcasting, a plurality of BS channels (frequency bands) are allocated, and 8 MPEG2-TSs at the maximum can be transmitted in each BS channel. Thirty two services can be transmitted in a TS. In the paragraphs that follow, a frequency band of the digital satellite broadcasting is referred to “BS channel” to distinguish it from a channel of each program which the receiver 1 receives.

An all-stations-SI is multiplexed in image or audio information of each TS. The all-stations-SI is an SI for all broadcasting stations and includes information about program arrangement for all channels. The all-stations-SI having the same contents is multiplexed in every TS of every BS channel. Therefore, if any channel of any broadcasting station is received in accordance with the user's selection, EGP data for all channels can be generated by obtaining the all-stations-SI included in a TS of the received channel. Specifically, the CPU 17 controls the de-multiplexer 6 to obtain the all-stations-SI from a TS presently received, and generates EPG text data on the basis of the all-stations-SI.

A configuration of image/audio data in each TS is indicated in FIG. 2. As mentioned above, thirty two services can be transmitted at the maximum in one TS. The services are time-division multiplexed in the form of a packet in one TS. As shown in an example of FIG. 2, services (service A, service B . . . ) of a plurality of broadcasting stations are time-division multiplexed in the TS located at the bottom. Therefore, for example, if the service A is selected as a service to be received, the CPU 17 controls the tuner 4 shown in FIG. 1 so that it is tuned in a BS channel including the TS in which the service A is time-division multiplexed. Then the decode processor 5 specifies an objective TS from a plurality of TS included in the BS channel and extracts it. Further, the de-multiplexer 6 extracts the service A, which is time-division multiplexed in the TS, by referring a identifying information.

As shown in FIG. 2, an each-station-SI is inserted in data (indicated as “service A”, “service B”) of each broadcasting station which provides each service. In FIG. 2, for convenience, the each-station-SI is inserted in the head of the data. Although the each-station-SI is similar information to the all-stations-SI, it includes unique information of each broadcasting station. Namely, while the all-stations-SI includes information necessary to display a program table as EPG for every channel, the each-station-SI includes, for example, detailed information about each program, etc. Therefore, if the CPU 17 obtains the each-station-SI in accordance with the user's instruction, detailed information about a specific program can be displayed.

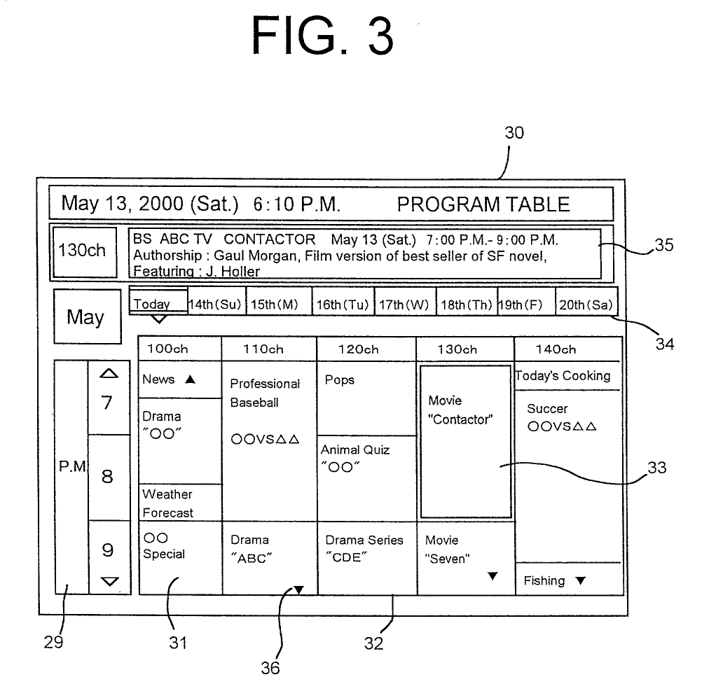

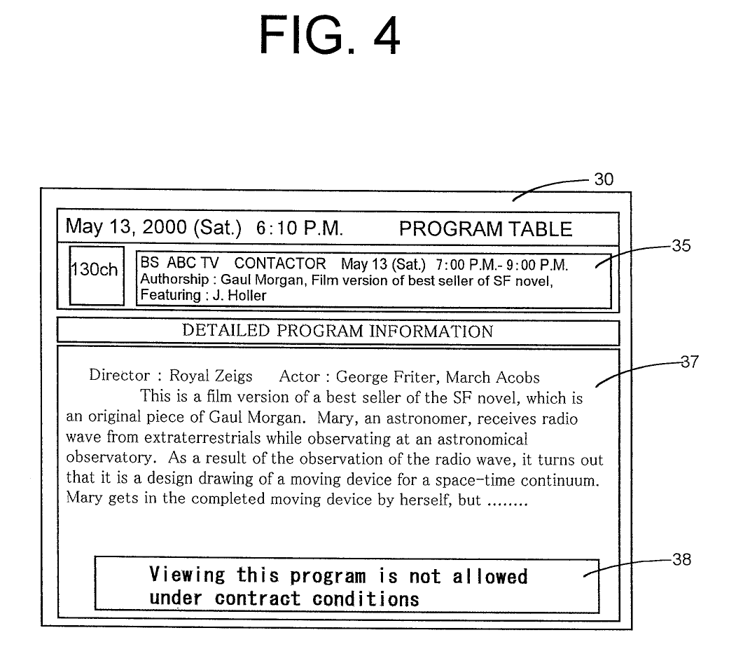

A screen image of EPG of the present invention will be explained. FIG. 3 and FIG. 4 show an example of the screen image of EPG. The screen image of EPG shown in FIG. 3 illustrates a program table of a plurality of channels for each day (each day of the week). This screen image of EPG is hereinafter referred to “Day-EPG”. The screen image of EPG shown in FIG. 4 illustrates detailed information of a specific program. This screen image of EPG is hereinafter referred to “Detailed-Program-Information-EPG”. In addition, there is “Genre-EPG” (not shown) which illustrates each program by each genre as another screen image of EPG. Any screen image of EPG can be fully displayed in the whole area of TV display, and can be superimposed on a screen image of a program presently viewed in a small area.

In the top portion of the Day-EPG, a current date and time are displayed. The Day-EPG 30 has a program table for 8 days from the current day as shown in FIG. 3. The program table is prepared for all the channels, for each day of the week. If a user designates a desirable day on a day tab 34, the program table of the desirable day is displayed. The program table is replaced with next day's one every time the below-mentioned “day change key 47” of the remote controller 12 is pressed. The program table of day after 6 days is displayed, then the program table of the current day is displayed again.

Each unit which is displayed within a program table display area 32 and partitioned with a frame is referred to as a program cell 31. A time period display area 29 is positioned on the left side of the program table display area 32. In FIG. 3 the program table for the time period from 7:00 p.m. to 10:00 p.m. on May 13th (Saturday) is displayed. At the top portion of the program table display area 32, channel numbers are displayed in a horizontal direction. In FIG. 3 three hours of program table is displayed in time-axis direction, and five channels of program table is displayed in channel-axis direction. However, it is not limited to this configuration. For example, it can be designed so as to display longer time and many channels at one time.

A continuation mark 36 is displayed in a program cell 31. The continuation mark 36 indicates that all of display area of the program cell 31 can not be displayed in a current program table display area 32 because the broadcast time of the program is long. The rest of the display area of the program cell 31 exists in the direction of the time-axis indicated by the mark 36. For example, although the broadcast time of the movie titled “Seven” starting at 9:00 p.m. in the 130-channel shown in FIG. 3 is two hours, the current program table display area 32 has the only area corresponding to the time period from 7:00 p.m. to 10:00 p.m. in FIG. 3. Therefore all of display area of the program cell 31 for the movie titled “Seven” can not be displayed completely. Hence, the fact that the program can continue even after 10:00 is indicated by using the continuation mark 36. An upward-pointing continuation mark 36 indicates that the time band of the program is longer than that is currently displayed on display area 32, and that the program cell 31 of the program continues in the upward direction (the direction indicating the preceding time band). A downward-pointing continuation mark 36 also indicates that the time band of the program is longer than that is currently displayed on the display area 32, and that the program cell 31 of the program continues in the downward direction (the direction indicating the succeeding time band).

A highlighted part denoted by a cursor 33 indicates the program which the user currently selects. An outline information about the program currently selected is illustrated in an outline information area 35 positioned in the top portion of the Day-EPG 30 show in FIG. 3. The outline information is generated on the basis of the all-stations-SI in each TS.

If the below-mentioned “INFO key 49” of the remote controller 12 is pressed while a program is selected as the highlighted part denoted by a cursor 33, Detailed-Program-Information-EPG shown in FIG. 4 is displayed. The Detailed-Program-Information-EPG is one for displaying detailed information of the program selected by the user. The detailed information is generated on the basis of each-station-SI in each TS. The Detailed-Program-Information-EPG corresponds to all program cells 31 illustrated in the Day-EPG in a one-to-one relationship, and is prepared for each program. The Detailed-Program-Information-EPG corresponds to all program cells in the Genre-EPG in a one-to-one relationship. As is the case with the Day-EPG, in the top portion of the Detailed-Program-Information-EPG, a current date and time are displayed, and under the top portion an outline information of the program is displayed in a outline information area 35 shown in FIG. 4. The detailed information is displayed in a detailed information display area 37. Further, under the detailed information display area 37, if the program, whose detailed information is currently displayed, is a program of conditional access and the user is not allowed to view the program in accordance with the above-mentioned contract conditions, a forbidden view information 38 is displayed. For example, a message is displayed as follows: “Viewing this program is not allowed under contract conditions”. The conditional access program receiving processor 7 and the CPU 17 determine whether the viewing the program is allowed or not by comparing the viewing conditions (for example, pay program or free-of-charge program) of the selected program with the contract conditions. If a program which the user has already made the contract to view is selected, a message indicating that viewing the program is allowed can be displayed, or no massage can be displayed. Consequently, the user can comprehend the contents of the program selected on the Day-EPG or the Genre-EPG before the program is received in the receiver 1, and know that the viewing the program is allowed or not. Therefore, that enhances the advertising effect to the program and provides an incentive to contract to view the program.

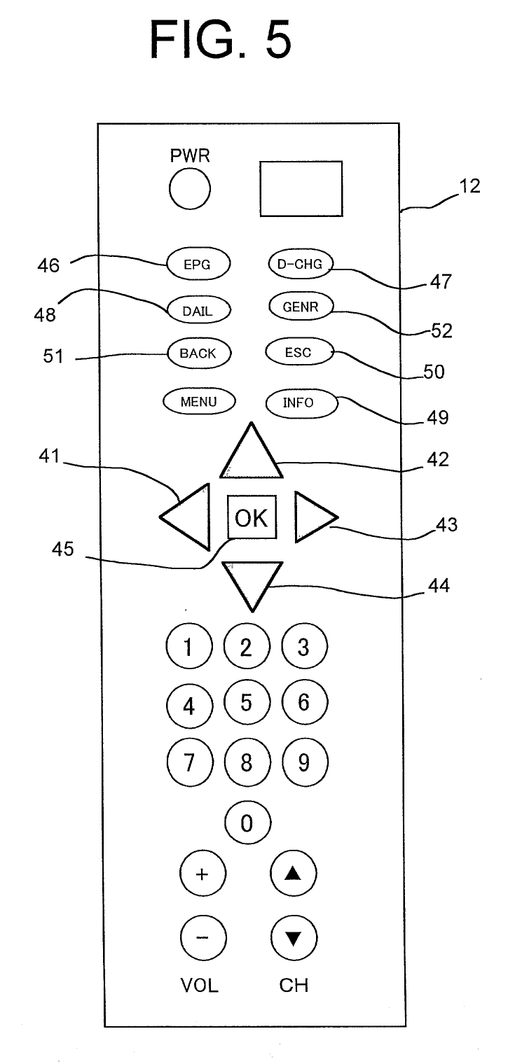

In FIG. 5, an outline view of the remote controller 12 which is used with the digital receiver 1 is illustrated An EPG key 46 in function keys positioned in the top portion of the remote controller 12 is used for instructing to display the screen image of EPG as shown in FIG. 3. If the EPG key 46 is pressed while a normal program is viewed, a screen of the TV display is switched to the screen image of EPG as shown in FIG. 3. The screen image of EPG can be imposed on a screen image of the program. If the EPG key 46 is pressed while the screen image of EPG is displayed, the screen returns to the screen image of the program. A day key 48 is positioned under the EPG key 46. The day key 48 is used for instructing to display the Day-EPG as shown in FIG. 3. The INFO key 49 is used for instructing to display the Detailed-Program-Information-EPG as shown in FIG. 4. The day selection key 47 is positioned in the right of the EPG key 46. The day changing key 47 is used for instructing to change the day of a program table currently displayed. A genre key 52 is positioned under the day changing key 47. The genre key 52 is used for instructing to switch the screen image of EPG with the Genre-EPG. An ESC key 50 is positioned under the genre key 52. The ESC key 50 is used for instructing to switch the screen image of EPG with the screen image of program. Further, a BACK key 51 is used for instructing to cancel an instruction previously input and return status to one before the instruction is inputted.

Cursor moving keys 41-44 are positioned in nearly center of the remote controller 12. The cursor moving keys 41-44 are used for instructing to move the cursor 33. In the status of display shown in FIG. 3, if a left direction key 41 is pressed, the cursor 33 is moved to the left program cell. If a right direction key 43 is pressed, the cursor 33 is moved to the right program cell. If an upward direction key 42 is pressed, the cursor 33 is moved to upward direction. If a downward direction key 44 is pressed, the cursor 33 is moved to downward direction.

However, even if the cursor 33 is just moved by pressing cursor moving keys 41-44, selection of a program is not defined in processing of the receiver 1. If an OK key 45 is pressed after the cursor 33 is moved, the selection of a program is defined. For example, in the example shown in FIG. 3, even if the cursor 33 is moved to the program cell of the program “Contactor” in CH 130 while the current time corresponds to the broadcast time of the program “Contactor”, the program has not received yet. After the OK key 45 is pressed, the receiver 1 switches a receiving channel to CH 130, starting to receive the program “Contactor”, and displaying the received screen image of it. If a program cell in a later (future) time band than the current time is designated by the cursor moving keys 41-44 and the OK key 45, a screen image for programming (reservation) is usually displayed. If predetermined procedure is done in accordance with instruction illustrated on the screen image for programming, the programming (reservation) of viewing or recording the program can be performed. In the case that past program information is erased at the time SI is sequentially renewed, if a program cell in a previous (past) time to the current time is designated, a message indicating that the program has already broadcast.

The other keys in the remote controller 12 shown in FIG. 5 is related to reception of normal TV program, and not directly related to the present invention. Therefore the explanation of them is omitted.

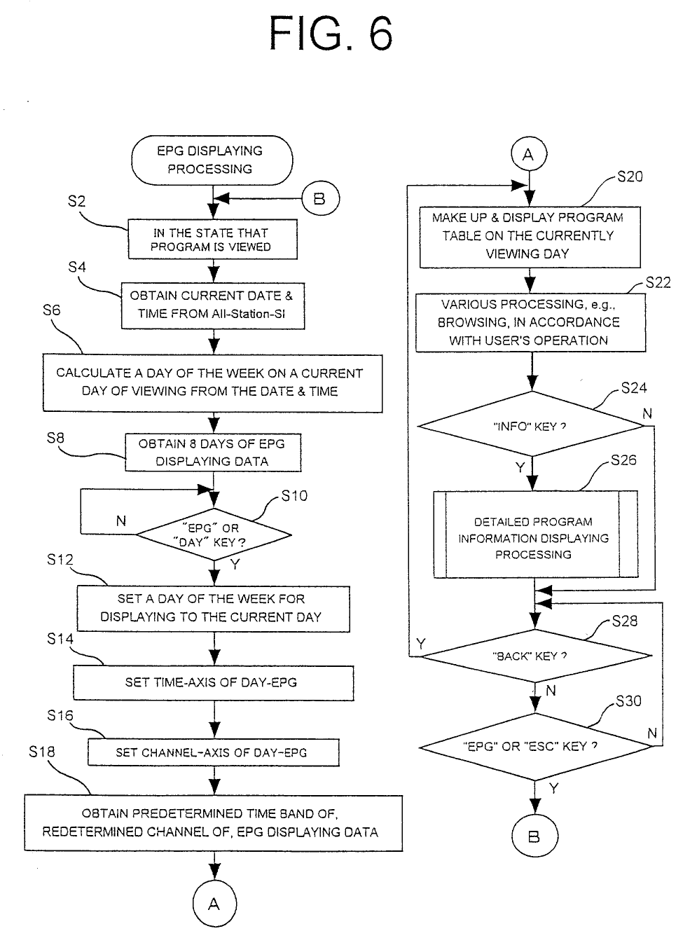

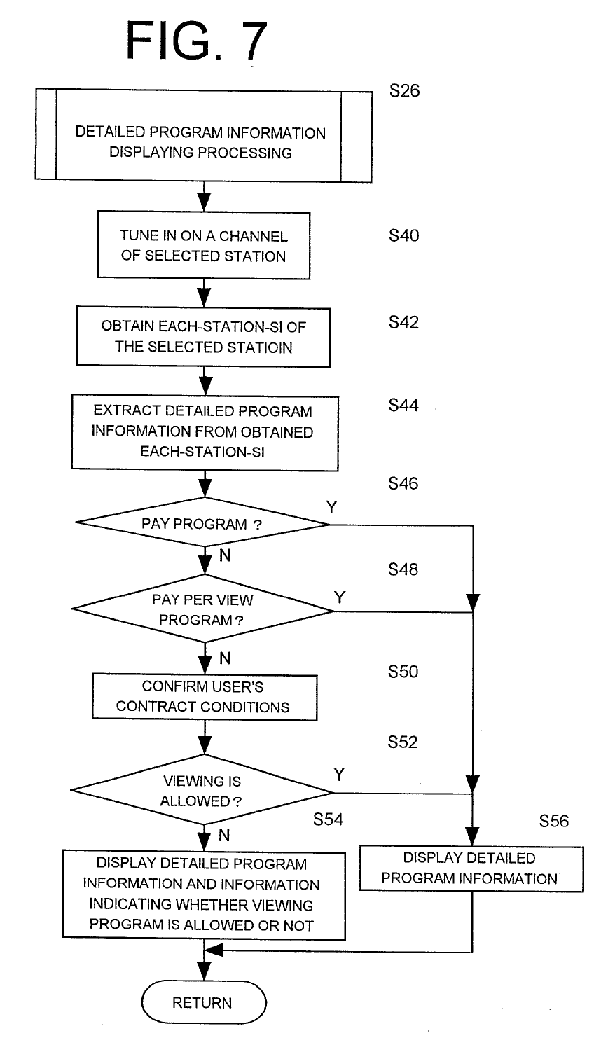

Next, processing of displaying the screen image of EPG will be explained with reference to the flow charts of FIG. 6 and FIG. 7. The CPU 17 is mainly concerned with the below-mentioned processing. The CPU 17 executes the predetermined processing program stored in the ROM 15 and controls the RAM 16, the display processor 9, etc.

FIG. 6 is a main routine showing the processing of displaying the Detailed-Program-Information-EPG. FIG. 7 is a sub routine showing the processing of displaying the detailed information.

If the user operates the receiver 1 to receive a desirable channel and views a program in the channel (Step S2), the receiver 1 extracts the all-stations-SI from TS of the channel currently being received, and obtains date and time data included in the all-stations-SI (Step S4). In the system of the embodiment, the broadcasting station which transmits a broadcasting wave manages the date and time data, and the current date and time data is included in the all-stations-SI. Therefore, the receiver 1 obtains the date and time data from a broadcasting wave. Then the receiver 1 calculates a day of the week on a current day of viewing on the basis of the obtained date and time data (Step S6). Generally, information about a day of the week is not included in the date and time data from the communication satellite. Therefore, it is necessary to specify a day of the week on the basis of the date and time data by using a predetermined calculating way of a calendar. Then the receiver 1 obtains EPG displaying data corresponding to data during 8 days from the current day (Step S8). Then if the EPG key 46 or the day key 48 is pressed by the user, the CPU 17 detects that (Step S10), setting a day of the week for displaying in the Day-EPG to the current day, and setting a day tab 34 indicating “Today” to selected state (Step S12, with reference to FIG. 3). Then the receiver 1 sets a time-axis of the Day-EPG to be displayed (Step S14). Specifically, the receiver 1 sets time of the top portion on a time band display area 48 for the hour of the current time.

Then the receiver 1 sets a channel-axis of the Day-EPG to be displayed (Step S16). Specifically, the receiver 1 maintains the channel-axis including the channel viewed at the time of pressing the EPG key 46 or the day key 48. Then the receiver 1 sets a range of displaying the program table (Step S18). For example, if the size of the program table which can be displayed at a time in accordance with the setting of the receiver 1 is m hours in the time-axis direction and n channels in the channel-axis, the receiver 1 sets the range for m hours from the hour indicated in the top portion of the time band display area 48, which is set in the Step S14, and n channels from the channel indicated in the extreme left of the channel-axis set in the Step S16. Then the receiver 1 obtains EPG display data corresponding to the range. The CPU 17 and the display processor 9 make up the program table by using the obtained EPG display data and display it on the TV display (Step S20).

Thus the Day-EPG is displayed as shown in FIG. 3. In this state, the receiver 1 performs various processing in accordance with the user's operation of the remote controller (Step S 22). For example, by pressing the day change key 47, the processing of changing the day of the program table currently displayed. Then the user operates the cursor keys 41-44 of the remote controller 12 to move the cursor 33 on the program cell, so that he selects the program in which he hopes that detailed program information is displayed. Then if the user presses the INFO key 49 while the cursor 33 is positioned on the program cell, the CPU 17 detects this (Step S24) and performs the processing of displaying detailed program information shown in FIG. 7 (Step S26).

In the processing of FIG. 7, for a start, the receiver 1 tunes in on a channel of the selected station (Step S40). Then the CPU 17 obtains the each-station-SI of the program from the TS of the tuned channel (Step S42), and extracts the detailed program information from it (Step S44). Then the CPU 17 in the receiver 1 refers the all-stations-SI previously obtained to determine whether the program is a pay program or not (Step S46). If it is determined that the program is free-of-charge, the processing shown in Step S56 is performed. On the other hand, if it is determined that the program is a pay program, the CPU 17 determines whether the program is a Pay Per View program or not (Step S48). If it is determined that the program is a Pay Per View program, the processing shown in Step S56 is performed. Generally, in the case of a Pay Per View program, the current system is set up in such a way that the user pays a prescribed fee after he viewed the program. In the embodiment, the pay-per-view program is distinguished from the conditional access program for which the user makes a contract before he views it.

On the other hand, if it is determined that the program is not the pay-per-view program in the Step S48, namely, that the program is the conditional access program, the CPU 17 confirms the contract conditions stored in the RAM 16 (Step S50), and determines whether the program is allowed to be viewed or not (Step S52). If it is determined that the program is not allowed to be viewed under the contract conditions, the CPU 17 displays the detailed program information extracted in the Step S44, reads data of information indicating whether viewing the program is allowed or not stored in the ROM 15, and displays it on the TV display (Step S54). On the other hand, if it is determined that viewing the program is allowed, only detailed program information is displayed on the TV display (Step S56). Thus the Detailed-Program-Information EPG shown in FIG. 4 is displayed, the user can realize the detailed program information, and whether viewing the program is allowed or not.

Then the processing returns to one shown in FIG. 6. If the user presses the BACK key 51, the CPU 17 detects this (Step S28), and the processing returns to one shown in the Step S20. However, even if the user presses the INFO key 49, not the BACK key 51, the Detailed-Program-Information EPG is switched to the Day-EPG. Then if the user presses the EPG key 46 or the ESC key 50, the CPU 17 detects this (Step S30), and the processing returns to one shown in the Step S2. Therefore the status of the screen returns to one that the program is viewed.

In the embodiment, the information indicating whether viewing the program is allowed or not, which is displayed with the detailed program information, is displayed on the Detailed-Program-Information EPG shown in FIG. 4, which is displayed by the INFO key 49. However, the forbidden viewing program information 38 can be displayed on the Day-EPG shown in FIG. 3, for example, in the program cell 31 or the outline information display area 35.

Moreover, in the embodiment, the present invention is applied to the program of the satellite broadcasting. However, the present invention is not limited to that example, it can be applied to a system broadcasting programs by a dedicated cable, a public circuit, or a system broadcasting by using the Internet. Further, in the embodiment, the screen image of EPG is displayed on the TV display. However, the present invention is not limited to the example, it can be displayed on a screen of a personal computer, etc.

Furthermore, in the embodiment, the information indicating whether viewing the program is allowed or not is displayed only when viewing the program is not allowed. However, the information indicating whether viewing the program is allowed can be also displayed when viewing the program is allowed.

The invention may be embodied in other specific forms without departing from the spirit or essential characteristics thereof. The present embodiments are therefore to be considered in all respects as illustrative and not restrictive, the scope of the invention being indicated by the appended claims rather than by the forgoing description and all changes which come within the meaning and range of equivalency of the claims are therefore intended to be embraces therein.

The entire disclosure of Japanese Patent Application No. P2000-61850 filed on Mar. 2, 2000 including the specification, claims, drawings and summary is incorporated herein by reference in its entirety.

What is claimed is:

1. An apparatus for displaying a program guide comprising:
a storing device for storing contract conditions of a plurality of programs;
a program information receiving device for receiving information about programs;
a program selection accepting device for accepting a selection of a desirable program from a plurality of the programs;
a contract conditions reading device for reading the contract conditions corresponding to a selected program whose selection is accepted;
a program information reading device for reading the information about the selected program;
a determining device for determining whether the selected program is allowed to be viewed by comparison between the read information and the read contract conditions; and
a displaying device for displaying information to specify the selected program, and information on the basis of the result of determining by the determining device on an identical screen, at least if the result of determining is that the selected program is not allowed to be viewed.

2. The apparatus for displaying a program guide according to claim 1, wherein the displaying device also displays information on the basis of the result of determining by the determining device on the identical screen, if the result of determining is that the selected program is allowed to be viewed.

3. The apparatus for displaying a program guide according to claim 1, wherein the information about programs read by the program information receiving device is provided by EPG data.

4. The apparatus for displaying a program guide according to claim 1, wherein the information about programs read by the program information reading device includes at least a name of the programs, information about the contents of the programs, start time of the programs, length of the programs or finish time of the programs, broadcasting channels of the programs, broadcasting dates of the programs, and viewing conditions of the programs;
the determining device determines whether the selected program is allowed to be viewed by comparison between the read viewing conditions and the read contract conditions; and
the displaying device displays at least the name of the selected program, the contents of the selected program, and information on the basis of the result of determining by the determining device on the identical screen, at least if the result of determining is that the selected program is not allowed to be viewed.

5. The apparatus for displaying a program guide according to claim 4, wherein the displaying device also displays information on the basis of the result of determining by the determining device on the identical screen, if the result of determining is that the selected program is allowed to be viewed.

6. The apparatus for displaying a program guide according to claim 4, wherein the information about programs read by the program information receiving device is provided by EPG data.

7. A method of displaying a program guide comprising the processes of:
storing contract conditions of a plurality of programs;
receiving information about programs;
accepting a selection of a desirable program from a plurality of the programs;
reading the contract conditions corresponding to a selected program whose selection is accepted;
reading the information about the selected program;
determining whether the selected program is allowed to be viewed by comparison between the read information and the read contract conditions; and
displaying information to specify the selected program, and information on the basis of the result of determining by the determining device on an identical screen, at least if the result of determining is that the selected program is not allowed to be viewed.

8. The method of displaying a program guide according to claim 7, wherein the process of displaying information also displays information on the basis of the result of determining by the determining device on the identical screen, if the result of determining is that the selected program is allowed to be viewed.

9. The method of displaying a program guide according to claim 7, wherein the received information about programs is provided by EPG data.

10. The method for displaying a program guide according to claim 7, wherein the received information about programs includes at least a name of the programs, information about the contents of the programs, start time of the programs, length of the programs or finish time of the programs, broadcasting channels of the programs, broadcasting dates of the programs, and viewing conditions of the programs;
the process of determining determines whether the selected program is allowed to be viewed by comparison between the read viewing conditions and the read contract conditions; and
the process of displaying displays at least the name of the selected program, the contents of the selected program, and information on the basis of the result of determining by the determining device on the identical screen, at least if the result of determining is that the selected program is not allowed to be viewed.

11. The method of displaying a program guide according to claim 10, wherein the process of displaying information also displays information on the basis of the result of determining by the determining device on the identical screen, if the result of determining is that the selected program is allowed to be viewed.

12. The method of displaying a program guide according to claim 10, wherein the received information about programs is provided by EPG data.
